(19) United States
(12) Patent Application Publication
(10) Pub. No.: US 2009/0053607 A1
(43) Pub. Date: Feb. 26, 2009

(54) Electrode for rechargeable lithium battery and rechargeable lithium battery including same

(76) Inventors: Goo-Jin Jeong, Suwon-si (KR); Nam-Soon Choi, Suwon-si (KR); Sang-Min Lee, Suwon-si (KR); Min-Seok Sung, Suwon-si (KR); Yong-Mook Kang, Suwon-si (KR); Sung-Soo Kim, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/155,545

(22) Filed: Jun. 5, 2008

(30) Foreign Application Priority Data
Aug. 24, 2007 (KR) 10-2007-0085577

(51) Int. Cl. H01M 4/58; B05D 5/12

(52) U.S. Cl. 429/231.95; 427/77

(57) ABSTRACT

The electrode for a rechargeable lithium battery includes a current collector and an active material layer disposed on the current collector. The active material layer has pores inside the active material layer. Porosity of the active material layer is higher than 50% and equal to or less than 70%. The pores formed inside the active material layer buffer against volume change that occurs during charges and discharges, and thereby improve cycle-life characteristic of a rechargeable lithium battery.

### CLAIM OF PRIORITY

This application makes reference to, incorporates the same herein, and claims all benefits accruing under 35 U.S.C. § 119 from an application earlier filed in the Korean Intellectual Property Office on 24 Aug. 2007 and there duly assigned Serial No. 10-2007-0085577.

### BACKGROUND OF THE INVENTION

1. Field of the Invention

The present invention relates to an electrode for a rechargeable lithium battery and a rechargeable lithium battery including the same. More particularly, the present invention relates to an electrode being capable of improving cycle-life due to an excellent buffer function against volume change of an active material.

2. Description of the Related Art

A rechargeable lithium battery has recently drawn attention as a power source for small portable electronic devices. It uses an organic electrolyte solution and thereby has twice the discharge voltage of a conventional battery that uses an alkali aqueous solution, and accordingly has high energy density.

The electrode in the rechargeable lithium battery may be fabricated by a method including preparing a composition for forming an active material layer including an active material for cathode or anode, preparing a binder and selectively conductive agent, applying the composition on a current collector, and then drying the composition-coated current collector to form an active material layer.

For a positive active material of a rechargeable lithium battery, lithium-transition element composite oxides being capable of intercalating lithium ion, such as LiCoO₂, LiMn₂O₄, LiNiO₂, LiNi₁₋ₓCoₓO₂ (0<x<1), LiNnO₂, and so on, have been researched.

Conventionally, lithium metals have been used as a negative active material for the rechargeable lithium battery. However, the cycle-life of the battery may be shortened due to formation of dendrites when the lithium metal is used. Therefore, carbonaceous materials, such as amorphous carbon, crystalline carbon, etc., have recently been used for the negative active material in place of lithium metals. The carbonaceous negative active material can solve problems caused by dendrites, and has voltage flatness at a low potential and good cycle-life characteristics. However, it has high reactivity with an organic electrolyte solution and a high diffusion rate of lithium, and therefore electric power characteristics, initial irreversible capacity, and electrode swelling at charge and discharge are required to be controlled.

In order to improve cycle-life, a lithium alloy has been researched for a negative active material. U.S. Pat. No. 6,051,340 discloses a negative electrode including a metal not alloyed with lithium and a metal alloyed with lithium. In this patent, the metal not alloyed with lithium acts as a current collector, and the metal alloyed with lithium forms an alloy with lithium ions that are released from a positive electrode during charging. Therefore a negative electrode includes lithium during charging. The alloy functions as a negative active material. However, the lithium alloy does not satisfactorily improve battery characteristics.

In addition, metal negative active materials such as silicon (Si), tin (Sn), a compound including Si or Sn, and so on have recently been studied as a substituent of the carbonaceous material. However, the Si or Sn has a problem of large irreversible capacity. Particularly, Si undergoes serious shrinkage or expansion during charge and discharge, and thereby a Si negative active material may be detached resulting in deterioration of cycle-life of a rechargeable lithium battery. Tin oxide disclosed by a Japanese company, Fuji Film. Co., Ltd. has come into the spotlight as an alternative to the carbonaceous negative active material. However, the metal negative active material has 30% or less initial Coulomb efficiency. Further, as lithium is continuously intercalated and deintercalated to generate a lithium-metal alloy, the capacity and cycle life are decreased and therefore it has not yet been commercialized.

Positive and negative electrodes of rechargeable lithium batteries are fabricated by applying a slurry composition including active materials, binders, and optionally conductive agents on current collectors. Aluminum has been used for a positive current collector and copper for a negative electrode.

Accordingly, much research has recently been undertaken to improve energy density of a rechargeable lithium battery.

### SUMMARY OF THE INVENTION

One embodiment of the present invention provides an electrode that is capable of improving cycle-life due to an excellent buffer function against volume change of an active material.

Another embodiment of the present invention provides a method of manufacturing the electrode.

Yet another embodiment of the present invention provides a rechargeable lithium battery having excellent energy density and cycle-life characteristics.

According to an embodiment of the present invention, provided is an electrode for a rechargeable lithium battery. The electrode includes a current collector, and an active material layer disposed on the current collector. The active material layer includes an active material. The active material layer has pores, and porosity of the active material layer is higher than 50% and no higher than 70%.

The active material layer has an active mass density ranging from 0.8 g/cc to 2.0 g/cc.

The active material layer may include at least one material selected from the group consisting of a monomer of an unzipping polymer, a plasticizer, an organic template, and mixtures thereof. an amount of the material, selected from the group consisting of a monomer of an unzipping polymer, a plasticizer, an organic template, and mixtures thereof, is equal to or less than 1000 ppm based on the total weight of the active material layer.

The monomer of the unzipping polymer is selected from the group consisting of alkylmethacrylate, vinylbutyral, and mixtures thereof. The plasticizer is selected from the group consisting of polyhydric alcohol, alkyl citrate, aliphatic polyester, alkylene carbonate, and mixtures thereof. The organic template is selected from the group consisting of polyalkyleneglycol, polystyrene, alkylammonium hydroxide, alkylammoniumhalide, and mixtures thereof.

The active material can be selected from the group consisting of Si, SiOₓ (0<x<2), Sn, SnO₂, and a metal-transition element alloy with a metal selected from the group consisting of Si, Sn, Al, and combinations thereof.

According to another embodiment of the present invention, provided is a method of manufacturing an electrode for a rechargeable lithium battery. The method includes preparing a composition for forming an active material layer, coating a current collector with the composition, and drying or heating the composition-coated current collector to form an active material layer on the current collector. The composition includes an active material, a pore-forming agent, and a binder.

The pore-forming agent is selected from the group consisting of an unzipping polymer, a plasticizer, an organic template, and mixtures thereof. The unzipping polymer is selected from the group consisting of an acrylate-based polymer, a vinyl-based polymer, and mixtures thereof. The plasticizer is selected from the group consisting of polyhydric alcohol, alkyl citrate, aliphatic polyester, alkylene carbonate, and mixtures thereof. The organic template is selected from the group consisting of polyalkyleneglycol, polystyrene, alkylammonium hydroxide, alkylammoniumhalide, and mixtures thereof.

An amount of the pore-forming agent may range from 0.01 wt % to 20 wt % based on the total weight of the composition for forming the active material layer.

The binder may include at least one selected from the group consisting of polyvinylalcohol, carboxymethylcellulose, hydroxymethylcellulose, diacetylene cellulose, polyvinylchloride, carboxylated polyvinylchloride, polyvinyl difluoride, an ethylene oxide-containing polymer, polyvinylpyrrolidone, polyurethane, polytetrafluoroethylene, polyvinylidenefluoride, polyethylene, polypropylene, styrene-butadiene rubber, acrylated styrene-butadiene rubber, an epoxy resin, nylon, polyimide, polyamideimide, and mixtures thereof.

The binder can be polyimide.

An amount of the binder may range from 1 wt % to 10 wt % based on the total weight of the composition for forming an active material layer.

The drying or heating process can be performed at a temperature between 50° C. to 500° C. The drying or heating process can be performed under an atmosphere selected from the group consisting of a vacuum, air, and a reducing atmosphere.

According to another embodiment of the present invention, provided is a rechargeable lithium battery including a positive electrode, a negative electrode, and an electrolyte. At least one of the positive and negative electrodes includes the electrode described above.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 shows a cross-sectional view of an electrode according to one embodiment of the present invention;

FIG. 2 is a flow chart showing a method of fabricating a rechargeable lithium battery according to another embodiment of the present invention;

FIG. 3 is a cross-sectional view of a rechargeable lithium battery according to still another embodiment of the present invention; and

FIG. 4 is a graph showing pore size distribution in the active material layer of the negative electrodes according to Example 1 and Comparative Examples 1, 3 of the present invention.

### DETAILED DESCRIPTION OF THE EMBODIMENTS

In a rechargeable lithium battery, active materials included in an electrode may expand and contract when the rechargeable lithium battery is charged and discharged. In particular, a metal alloy-based or silicon or tin-based negative active material has a severe volume change. The volume change of the active materials may deteriorate the cycle-life characteristic of the rechargeable lithium battery.

Therefore, the present invention provides a porous electrode including a pore-forming agent, so that it can buffer the electrode against the volume change of an active material during charges and discharges of a lithium rechargeable battery, and thereby improve the cycle-life characteristic thereof.

In this specification, when specific description is not provided, “an alkyl” refers to a C₁-C₂₀ alkyl, and “an alkylene” refers to a C₁-C₂₀ alkylene.

In other words, according to one embodiment of the present invention, an electrode for a rechargeable lithium battery includes a current collector and an active material layer disposed on the current collector. The active material layer may have porosity ranging more than 50% and equal to and less than 70% based on its entire volume.

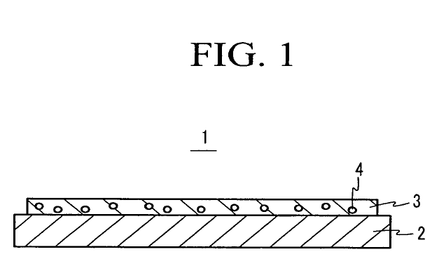

FIG. 1 shows a cross-sectional view of an electrode for a rechargeable lithium battery constructed as one embodiment of the present invention, but the present invention is not limited thereto. Referring to FIG. 1, an electrode 1 of one embodiment of the present invention includes a current collector 2 and an active material layer 3 disposed on the current collector 2. Pores 4 are formed inside the active material layer.

The current collector 2 may be selected from the group consisting of an aluminum foil, a copper foil, a nickel foil, a stainless steel foil, a titanium foil, a nickel foam, an aluminum foam, a copper foam, and a polymer material coated with a conductive metal. When the current collector 2 is used for a positive electrode, an aluminum-based current collector is preferred. When the current collector 2 is used for a negative electrode, a copper-based current collector is preferred. The polymer material may be selected from the group consisting of polyethylene terephthalate, polyimide, polytetrafluoroethylene, polyethylene naphthalate, polypropylene, polyethylene, polyester, polyvinylidene fluoride, polysulfone, and mixtures thereof.

The active material layer 3 is disposed on the current collector 2. The active material layer 3 is formed by coating the current collector with a composition for forming an active material layer including an active material and a pore-forming agent, and thereafter by evaporating the pore-forming agent. Accordingly, it includes pores 4 formed after the pore-forming agent is evaporated.

Herein, the size, shape, and porosity of pores formed in an active material layer may be determined by the size, shape, and amount of the pore-forming agent used for forming the active material layer. The active material layer may have porosity of more than 50% and equal to or less than 70%, but according to another embodiment of the present invention, it may have porosity of 51%, 0.54%, 57%, 60%, 63%, 66%, 68%, and 70%. Herein, porosity of the active material layer means the ratio of the volume of all the pores included in the active material layer to the volume of the active material layer. When an active material layer has porosity of equal to or less than 50%, it may have little buffering effect. On the other hand, when it has porosity of more than 70%, electrode conductivity may decrease, or capacity per volume may decrease.

The active material layer 3 can be electrochemically oxidized/reduced and includes an active material. The active material may include an appropriate compound depending on uses of the electrode.

When the electrode 1 is adapted to a negative electrode, the active material layer 3 includes at least one selected from the group consisting of lithium, a metal material that can be alloyed with lithium, a transition element oxide, a material that is reversibly capable of doping and dedoping with lithium, a material that is reversibly capable of forming a lithium-containing compound, and a material that is reversibly capable of intercalating and deintercalating lithium. The metal that can be alloyed with lithium may include Na, K, Rb, Cs, Fr, Be, Mg, Ca, Sr, Ba, Ra, Ti, Ag, Zn, Cd, Al, Ga, In, Si, Ge, Sn, Pb, Sb, Bi, and the like.

In addition, the negative active material may include metal lithium. Examples of the transition elements oxide, a material that is reversibly capable of doping and dedoping with lithium, and a material that is reversibly capable of forming a lithium-containing compound include vanadium oxide, lithium vanadium oxide, Si, SiOₓ (0≦x≦2), Sn, SnO₂, and a metal-transition element alloyed with a metal selected from the group consisting of Si, Sn, Al, and combinations thereof. Examples of the material that is reversibly capable of intercalating and deintercalating lithium include a carbonaceous material. The carbonaceous material may include crystalline carbon, amorphous carbon, and the like. Examples of the crystalline carbon include amorphous, plate-shaped, flake, spherical, or fiber-shaped natural graphite or artificial graphite, and examples of the amorphous carbon include soft carbon (low temperature fired carbon) or hard carbon, mesophase pitch carbide, fired coke, and so on.

When the electrode 1 is adapted to a positive electrode, the active material layer 3 includes a lithiated intercalation compound being capable of reversibly intercalating and deintercalating lithium ions. Specifically, the positive active material includes compounds of the following Chemical Formulas 1 to 24.

LiₐA_{1-b}B_{b}D₂ Chemical Formula 1

wherein, in the above formula, 0.95=a=1.1 and 0=b=0.5.

LiₐE_{1-b}B_{b}O_{2-c}F_{c} Chemical Formula 2

wherein, in the above formula, 0.95=a=1.1, 0=b=0.5, and 0=c=0.05.

LiE_{2-b}B_{b}O_{4-c}F_{c} Chemical Formula 3

wherein, in the above formula, 0=b=0.5 and 0=c=0.05.

LiₐNi_{1-b-c}Co_{b}B_{c}Dₐ Chemical Formula 4

wherein, in the above formula, 0.95=a=1.1, 0=b=0.5, 0=c=0.05, and 0<a=2.

LiₐNi_{1-b-c}Co_{b}B_{c}O₂₋ₐFₐ Chemical Formula 5

wherein, in the above formula, 0.95=a=1.1, 0=b=0.5, 0=c=0.05, and 0<a<2.

LiₐNi_{1-b-c}Co_{b}B_{c}O₂₋ₐF₂ Chemical Formula 6

wherein, in the above formula, 0.95=a=1.1, 0=b=0.5, 0=c=0.05, and 0<a<2.

LiₐNi_{1-b-c}Mn_{b}B_{c}Dₐ Chemical Formula 7

wherein, in the above formula, 0.95=a=1.1, 0=b=0.5, 0=c=0.05, and 0<a=2.

LiₐNi_{1-b-c}Mn_{b}B_{c}O₂₋ₐFₐ Chemical Formula 8

wherein, in the above formula, 0.95=a=1.1, 0=b=0.5, 0=c=0.05, and 0<a<2.

LiₐNi_{1-b-c}Mn_{b}B_{c}O₂₋ₐF₂ Chemical Formula 9

wherein, in the above formula, 0.95=a=1.1, 0=b=0.5, 0=c=0.05, and 0<a<2.

LiₐNi_{b}E_{c}G_{d}O₂ Chemical Formula 10

wherein, in the above formula, 0.90=a=1.1, 0=b=0.9, 0=c=0.9, and 0.001=d=0.2.

LiₐNi_{b}Co_{c}Mn_{d}GₑO₂ Chemical Formula 11

wherein, in the above formula, 0.90=a=1.1, 0=b=0.9, 0=c=0.5, 0=d=0.5, and 0.001=e=0.2.

LiₐNiG_{b}O₂ Chemical Formula 12

wherein, in the above formula, 0.90=a=1.1 and 0.001=b=0.1.

LiₐCoG_{b}O₂ Chemical Formula 13

wherein, in the above formula, 0.90=a=1.1 and 0.001=b=0.1.

LiₐMnG_{b}O₂ Chemical Formula 14

wherein, in the above formula, 0.90=a=1.1 and 0.001=b=0.1.

LiₐMn₂G_{b}O₄ Chemical Formula 15

wherein, in the above formula, 0.90=a=1.1 and 0.001=b=0.1.

QO₂ Chemical Formula 16

QS₂ Chemical Formula 17

LiQS₂ Chemical Formula 18

V₂O₅ Chemical Formula 19

LiV₂O₅ Chemical Formula 20

LiIO₂ Chemical Formula 21

LiNiVO₄ Chemical Formula 22

Li_{3-f}J₂(PO₄)₃ (0=f=3) Chemical Formula 23

Li_{3-f}Fe₂(PO₄)₃ (0=f=2) Chemical Formula 24

In the above Chemical Formulas 1 to 24, A is selected from the group consisting of Ni, Co, Mn, and combinations thereof. B is selected from the group consisting of Al, Ni, Co, Mn, Cr, Fe, Mg, Sr, V, a rare earth element, and combinations thereof. D is selected from the group consisting of O, F, S, P, and combinations thereof. E is selected from the group consisting of Co, Mn, and combinations thereof. F is selected from the group consisting of F, S, P, and combinations thereof. G is selected from the group consisting of Al, Cr, Mn, Fe, Mg, La, Ce, Sr, V, a lanthanide element, and combinations thereof. Q is selected from the group consisting of Ti, Mo, Mn, and combinations thereof. I is selected from the group consisting of Cr, V, Fe, Sc, Y, and combinations thereof. J is selected from the group consisting of V, Cr, Mn, Co, Ni, Cu, and combinations thereof.

In addition, the positive active material may include inorganic sulfur (S₈, elemental sulfur) and a sulfur-based compound. The sulfur-based compound may include Li₂Sₙ (n=1), Li₂Sₙ (n=1) dissolved in a catholyte, an organic sulfur compound, a carbon-sulfur polymer ((C₂Sf)ₙ: f=2.5 to 50, n=2), or the like.

When the material selected from the group consisting of Si, SiOₓ (0<x<2), Sn, SnO₂, and a metal-transition element alloyed with a metal selected from the group consisting of Si, Sn, Al, and combinations thereof is used as a negative active material, an electrode is capable of improving cycle-life due to an excellent buffer function against volume change of an active material.

The active material layer 3 also includes a binder for improvement of its adherence to a current collector and improvement of adherence among active materials, and a conductive agent for improving electrical conductivity. Examples of the binder include at least one selected from the group consisting of polyvinylalcohol, carboxymethylcellulose, hydroxymethylcellulose, diacetylene cellulose, polyvinylchloride, carboxylated polyvinylchloride, polyvinyl difluoride, an ethylene oxide-containing polymer, polyvinylpyrrolidone, polyurethane, polytetrafluoroethylene, polyvinylidenefluoride, polyethylene, polypropylene, styrene-butadiene rubber, acrylated styrene-butadiene rubber, an epoxy resin, nylon, polyimide, and polyamideimide. According to another embodiment of the present invention, polyimide with a proper strength may be used as a binder due to an excellent buffer function against volume change of an active material.

Any electrically conductive material can be used as a conductive agent unless it causes a chemical change. Examples of the conductive agent include natural graphite, artificial graphite, carbon black, acetylene black, keten black, a carbon fiber, a metal powder or a metal fiber including copper, nickel, aluminum, silver, and so on, and a polyphenylene derivative.

In addition, the active material layer 3 may include a residue of a pore-forming agent not having evaporated during formation of pores, or its reactant. The pore-forming agent may include an unzipping polymer such as an acrylate-based polymer, a vinyl-based polymer, or the like. The unzipping polymer may be completely decomposed into monomers, as the monomers are consecutively separated one by one from both ends of a main chain thereof or the other end that is formed after the main chain is cut off. In particular, it may include polyalkyl(metha)acrylate, polyvinylbutyral, and the like. Herein, the alkyl group may be selected from the group consisting of an alkyl with 1 to 20 carbons. According to another embodiment of the present invention, it may include an alkyl group with 1 to 6 carbons including methyl, ethyl, n-propyl, isopropyl, n-butyl, isobutyl, sec-butyl, t-butyl, pentyl, iso-amyl, hexyl, or the like, and according to still another embodiment of the present invention, it may include a lower alkyl with 1 to 3 carbons.

The above unzipping polymers are evaporated into a monomer produced during the unzipping reaction. Some monomers may not be evaporated but remain in an active material layer. The monomer may include alkylmethacrylate, vinylbutyral, and mixtures thereof.

The pore-forming agent may include a plasticizer selected from the group consisting of polyhydric alcohol such as glycerine, an alkylcitrate such as sodium triethylcitrate, an aliphatic polyester, an alkylenecarbonate such as propylenecarbonate, and so on.

The alkyl group may be the same as aforementioned. The alkylene group has a radical shape, in which both ends of an alkyl group can be combined. Herein, the alkyl group is the same as defined above.

In addition, the monomer may include an organic template including one selected from the group consisting of a polyalkyleneglycol such as polyethyleneglycol, and polypropyleneglycol; polystyrene; an alkylammoniumhydroxide such as cetyltrimethylammoniumhydroxide; an alkylammoniumhalide such as cetyltriethylammonium bromide; and the like. The alkyl group and the alkylene group may be the same as aforementioned.

Accordingly, the plasticizer or the organic template may remain inside a final complete active material layer 3.

The pore-forming agent or its reactant may be included in an amount of equal to and less than 1000 ppm inside an active material layer 3, but according to another embodiment of the present invention, it may be included in an amount ranging from 1 to 100 ppm. When a pore-forming agent or its reactant remains in an amount of more than 1000 ppm inside an active material layer, a desired porosity may not be obtained, or the adherence of a binder may decrease.

On the other hand, an active material layer 3 including the aforementioned components and pores may have an active mass density ranging from 0.8 g/cc to 2.0 g/cc, and according to another embodiment of the present invention, it may have active mass density ranging from 0.9 g/cc to 1.6 g/cc. And according to still another embodiment of the present invention, it may have active mass density ranging from 1.19 g/cc to 1.3 g/cc. When an active material layer has mass density of less than 0.8 g/cc, capacity per volume may decrease, while when it has mass density of more than 2.0 g/cc, the active material layer may expand significantly.

The electrode including the above active material layer may be fabricated by a method that includes a step of preparing a composition for forming an active material layer including an active material, a pore-forming agent, and a binder, and a step of applying the composition for forming an active material layer on a current collector, and then drying or heating the composition-formed current collector to form an active material layer.

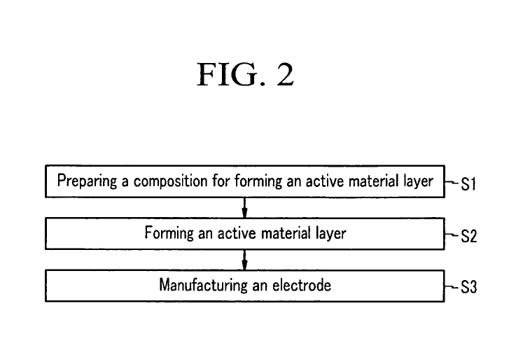

FIG. 2 is a flow chart showing a method of fabricating a rechargeable lithium battery according to another embodiment of the present invention. Illustrating in more detail with reference to FIG. 2, a method of fabricating an electrode for a rechargeable lithium battery is further described.

First, an active material, a pore-forming agent, and a binder are dissolved in a solvent to prepare a composition for forming an active material layer (SI).

The active material may be a lithiated intercalation compound being capable of reversibly intercalating and deintercalating lithium ions as described above.

The pore-forming agent may be an unzipping polymer, a plasticizer, or an organic template as described above. The pore-forming agent may be appropriately included considering porosity and possibility of the pore-forming agent inside the aforementioned active material layer. In particular, the pore-forming agent may be included in an amount ranging from 1 to 20 wt % based on the total weight of a composition for forming an active material layer, but according to another embodiment of the present invention, it may be included in an amount ranging from 4 to 16 wt %. When a pore-forming agent is included in an amount of less than 1 wt %, porosity may decrease, while when it is included in an amount of more than 20 wt %, the capacity per volume may decrease.

The binder is the same as above. The binder may be included in an amount ranging from 1 to 10 wt % based on the total weight of a composition for forming an active material layer, but according to another embodiment of the present invention, it may be included in an amount ranging from 3 to 7 wt %. When a binder is included in an amount of less than 1 wt %, its adherence may decrease, while when it is included in an amount of more than 10 wt %, the capacity per volume may decrease.

According to one embodiment of the present invention, a composition for forming an active material layer can include a conductive agent. The conductive agent may include any electrically conductive material, so far as it does not cause chemical changes in a battery as aforementioned.

The solvent may include an alcohol such as methanol, ethanol, or isopropanol, or hexane, chloroform, tetrahydrofuran, ether, methylene chloride, acetone, acetonitrile, N-methylpyrrolidone (NMP), and the like, but is not limited thereto. The composition for forming an active material layer may include an amount of residual solvent.

According to one embodiment of the present invention, a composition for forming an active material layer is applied on a current collector and dried or heated to form an active material layer (S2), and thereby an electrode is formed (S3).

The current collector is the same as aforementioned.

The coating method may include a method that can be used for coating slurry. In particular, it may include screen printing, spray coating, doctor blade method, gravure coating, dip-coating, silk-screening, painting, or the like, but is not limited thereto.

The drying process or heating process may be performed at a temperature ranging from 50 to 500° C. In addition, it may be performed under vacuum, air, or an inert gas atmosphere. However, the drying or heating temperature and atmosphere may need to be determined depending on the kind of pore-forming agent.

In particular, when an unzipping polymer is included as a pore-forming agent, it should be dried or heated at a temperature ranging from 200 to 500° C., so that it may have a sufficient unzipping polymerization reaction and evaporation of a monomer produced from the unzipping polymerization reaction. However, according to another embodiment of the present invention, it may be dried or heated at a temperature ranging from 350 to 450° C.

In addition, when an unzipping polymer is used as a pore-forming agent, it may be dried under an inert gas atmosphere such as nitrogen, argon, and the like. Furthermore, the drying or heating process may be performed for 10 minutes to 4 hours, but according to another embodiment of the present invention, it can be performed for 30 minutes to 1 hour, so that a monomer produced from the unzipping polymerization reaction of a polymer can be sufficiently evaporated.

On the other hand, when a plasticizer is used as a pore-forming agent, its drying or heating process may be performed at a temperature ranging from 50 to 200° C., but according to another embodiment of the present invention, it may be performed at a temperature ranging from 100 to 150° C. When the drying or heating process is performed out of the temperature range, the current collector may be oxidized.

The drying or heating process may be performed under vacuum. Furthermore, it can be performed for 10 minutes to 24 hours, but according to another embodiment, it can be performed for 1 to 12 hours, so that a plasticizer included in an active material layer can be sufficiently evaporated.

Next, when an organic template is included as a plasticizer, its drying or heating process can be performed at a temperature ranging from 50 to 500° C., but according to another embodiment, it can be performed at a temperature ranging from 100 to 400° C. When the drying temperature is out of the range, the current collector may be oxidized.

In addition, when an organic template is used as a pore-forming agent, its drying or heating process may be performed under vacuum or an air atmosphere. The drying or heating process may be performed for 10 minutes to 24 hours, but according to another embodiment, it can be performed for 1 to 12 hours, so that the organic template can be sufficiently evaporated.

When the drying process is complete, pores are formed as a result.

In general, fabrication of an electrode can include a compression process, but the present invention should not include a compression process in order to maintain pores formed inside an active material layer.

The size, shape, amount, and distribution of pores can be changed by controlling the size, shape, amount, distribution, and drying condition of a pore-forming agent used for forming pores in an active material layer.

Then, an electrode fabricated according to the manufacturing method can be used as a positive electrode or a negative electrode depending on the kind of active material included in an active material layer. In addition, it can include pores that can easily change their sizes of shapes in the active material layer, so that the pores can absorb a volume change according to contraction and expansion of the active material during the battery operation, and thereby suppress expansion of the electrode and a battery including it, improving the cycle-life characteristic thereof. In addition, the present invention can have an excellent effect on a negative electrode including a metal material that can be alloyed with lithium, which has a large volume change, as a negative active material.

In addition, the present invention provides a rechargeable lithium battery including an electrode fabricated as aforementioned. Rechargeable lithium batteries may be classified as lithium ion batteries, lithium ion polymer batteries, and lithium polymer batteries according to the presence of a separator and the kind of electrolyte used in the battery. The rechargeable lithium batteries may have a variety of shapes and sizes, including cylindrical, prismatic, coin or pouch-type batteries, and may be a thin film battery or be rather bulky in size. Structures and fabricating methods for lithium ion batteries pertaining to the present invention are well known in the art.

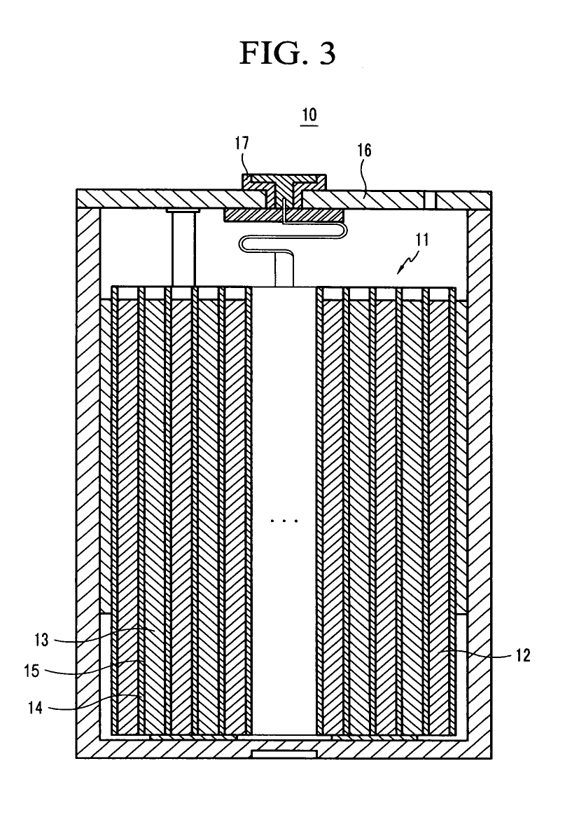

FIG. 3 shows a structure of a rechargeable lithium battery according to one embodiment of the present invention. While FIG. 3 shows a structure of cylindrical-type battery, it is to be understood that the battery according to the invention is not limited to the FIG. 3 but is intended to cover prismatic or pouch-type batteries.

The rechargeable lithium battery 10 having the structure may be fabricated as follows. An electrode assembly 12 includes a positive electrode 13, a negative electrode 14, and a separator 15 interposed between the positive electrode 13 and the negative electrode 14. The electrode assembly 12 is placed in a battery case 16. Electrolyte 11 is provided through the opening of the battery case 16, and the case 16 is sealed with a cap plate 17. At least one of the positive and negative electrodes 13 and 14 is the above-described electrode.

In the rechargeable battery according to one embodiment of the present invention, a non-aqueous electrolyte or solid electrolyte can be used for the electrolyte.

The non-aqueous electrolyte includes a lithium salt dissolved in a non-aqueous organic solvent. The lithium salt facilitates a basic operation of a rechargeable lithium battery, and allows transmission of lithium ions between positive and negative electrodes. Non-limiting examples of the lithium salt include at least one supporting electrolyte salt selected from the group consisting of LiPF₆, LiBF₄, LiSbF₆, LiAsF₆, LiClO₄, LiCF₃SO₃, LiC₄F₉SO₃, LiN(CF₃SO₂)₂, LiN(C₂F₅SO₂)₂, LiAlO₂, LiAlCl₄, LiN(CpF₂ₚ₊₁SO₂)(C_{q}F_{2q+1}SO₂) (where p and q are natural numbers), LiCl, LiI, lithium bisoxalate borate, and combinations thereof.

The lithium salt may be used at a 0.6 to 2.0 M concentration. According to one embodiment, the lithium salt may be used at a 0.7 to 1.6 M concentration. When the lithium salt concentration is less than 0.6 M, electrolyte performance may be deteriorated due to low electrolyte conductivity, whereas when it is more than 2.0 M, lithium ion mobility may be reduced due to an increase of electrolyte viscosity.

The non-aqueous organic solvent acts as a medium for transmitting ions taking part in the electrochemical reaction of the battery. The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), and so on. Examples of the ester-based solvent may include n-methyl acetate, n-ethyl acetate, n-propyl acetate, dimethylacetate, methylpropionate, ethylpropionate, γ-butyrolactone, decanolide, valerolactone, mevalonolactone, caprolactone, and so on. Examples of the ether-based solvent include dibutyl ether, tetraglyme, diglyme, dimethoxyethane, 2-methyltetrahydrofuran, tetrahydrofuran, and so on, and examples of the ketone-based solvent include cyclohexanone and so on. Examples of the alcohol-based solvent include ethanol, isopropyl alcohol, and so on. Examples of the aprotic solvent include a nitrile such as X—CN (wherein X is a C2 to C20 linear, branched, or cyclic hydrocarbon, a double bond, an aromatic ring, or an ether bond), an amide such as dimethylformamide, a dioxolane such as 1,3-dioxolane, sulfolane, and so on.

The non-aqueous organic solvent may be used by itself or as a mixture. When the organic solvent is used as a mixture, the mixture ratio can be controlled in accordance with a desirable battery performance.

The carbonate-based solvent may include a mixture of a cyclic carbonate and a linear carbonate. When the cyclic carbonate and the chain carbonate are mixed together in a volume ratio of 1:1 to 1:9, and the mixture is used as an electrolyte, the electrolyte performance may be enhanced.

In addition, the electrolyte according to one embodiment of the present invention may further include mixtures of carbonate-based solvents and aromatic hydrocarbon-based solvents. The carbonate-based solvents and the aromatic hydrocarbon-based solvents are preferably mixed together in a volume ratio of 1:1 to 30:1. The aromatic hydrocarbon-based organic solvent may be represented by the following Chemical Formula 25:

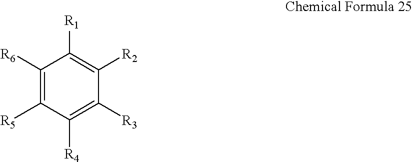

wherein R₁, to R₆ are independently selected from the group consisting of hydrogen, a halogen, a C1 to C10 alkyl, a haloalkyl, and combinations thereof.

The aromatic hydrocarbon-based organic solvent may include, but is not limited to, at least one selected from the group consisting of benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and combinations thereof.

The electrolyte may further include an additive such as a vinylene carbonate, and an ethylene carbonate-based compound represented by the following Chemical Formula 26 to improve cell life-characteristics.

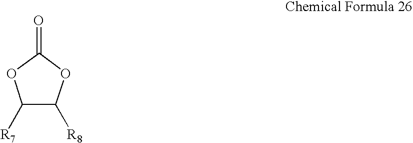

In the above Formula 26, R₇ and R₈ are independently selected from the group consisting of hydrogen, a halogen, a cyano (CN), a nitro (NO₂), and a fluorinated C1 to C5 alkyl, provided that at least one of R₇ and R₈ is selected from the group consisting of a halogen, a cyano (CN), a nitro (NO₂), and a fluorinated C1 to C5 alkyl.

According to one embodiment, the ethylene carbonate-based compound may be selected from the group consisting of difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and combinations thereof.

The additive is not limited by a specific amount, and may be added in an appropriate amount to improve cycle-life characteristics.

The solid electrolyte may include a polymer electrolyte of polyethylene oxide or a polymer electrolyte composed of at least one polyorganosiloxane side chain or polyoxyalkylene side chain; a sulfide electrolyte such as Li₂S—SiS₂, Li₂S—GeS₂, Li₂S—P₂S₅, Li₂S—B₂S₃, and the like; and an inorganic compound electrolyte such as Li₂S—SiS₂—Li₃PO₄, Li₂S—SiS₂—Li₃SO₄, and the like.

The rechargeable lithium battery generally includes a separator between the positive electrode and the negative electrode. The separator may include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The following examples illustrate the present invention in more detail. These examples, however, should not in any sense be interpreted as limiting the scope of the present invention.

### Example 1

### Fabrication of a Negative Electrode

0.5 g of pore-forming polymethylmethacrylate was dissolved in 2.5 ml of N-methylpyrrolidone that is a solvent. Then, 4.5 g of silicon as a negative active material and 0.5 g of polyimide as a binder were added to the solution, preparing a composition for forming a negative active material. The composition for forming a negative active material was formed on a thin Cu film that is a current collector by a screen printing method, and then dried at 400° C. under a nitrogen atmosphere, preparing a negative electrode.

### Example 2

### Fabrication of a Negative Electrode

0.5 g of pore-forming glycerine was dissolved in 2.5 ml of N-methylpyrrolidone that is a solvent. Then, 4.5 g of silicon as a negative active material and 0.5 g of polyimide as a binder were added to the solution, preparing a composition for forming a negative active material layer. The composition for forming a negative active material layer was formed on a thin Cu film that is a current collector by a screen printing method, and then dried at 150° C. under vacuum, preparing a negative electrode.

### Example 3

### Fabrication of a Negative Electrode

0.5 g of pore-forming polyethyleneglycol was dissolved in 2.5 ml of N-methylpyrrolidone that is a solvent. Then, 4.5 g of silicon as a negative active material and 0.5 g of polyimide as a binder were added to the solution, preparing a composition for forming a negative active material. The composition for forming a negative active material was coated on a thin Cu film that is a current collector by a screen printing method, and then dried at 300° C. under vacuum, preparing a negative electrode.

### Example 4

### Fabrication of a Negative Electrode

A negative electrode was fabricated according to the same method as in Example 1, except for using 0.005 g of pore-forming polymethylmethacrylate.

### Example 5

### Fabrication of a Negative Electrode

A negative electrode was fabricated according to the same method as in Example 1, except for using 1.25 g of pore-forming polymethylmethacrylate.

### Comparative Example 1

### Fabrication of a Negative Electrode

4.5 g of silicon as a negative active material and 0.5 g of polyimide as a binder were dissolved in 2.5 ml of N-methylpyrrolidone that is a solvent, preparing a composition for forming a negative active material. The composition for forming a negative active material was formed on a thin Cu film by a screen printing method, and then dried and compressed under a pressure of 2 tons/cm², preparing a negative electrode.

### Comparative Example 2

### Fabrication of a Negative Electrode

0.001 g of pore-forming polymethylmethacrylate was dissolved in 2.5 ml of N-methylpyrrolidone that is a solvent. Then, 4.5 g of silicon as a negative active material and 0.5 g of polyimide as a binder were added to the solution, preparing a composition for forming a negative active material layer. The composition for forming a negative active material layer was coated on a thin Cu film that is a current collector by a screen printing method, and then dried at 400° C. under a nitrogen atmosphere for 1 hour and compressed under a pressure of 2 tons/cm², preparing a negative electrode.

### Comparative Example 3

### Fabrication of a Negative Electrode

A negative electrode was prepared according to the same method as in Comparative Example 2 except for using 3 g of polymethylmethacrylate.

### Experimental Example 1

The negative electrodes prepared according to the processes of Examples 1 to 5 and Comparative Examples 1 to 3 were examined to measure their porosity and mass density in the negative active material layers. The results are shown in the following Table 1.

TABLE 1

| | | Mass density |
|---|---|---|
| | Porosity (%) | (g/cc) |
| Example 1 | 65 | 1.25 |
| Example 2 | 65 | 1.25 |
| Example 3 | 65 | 1.25 |
| Example 4 | 53 | 1.3 |
| Example 5 | 70 | 1.19 |
| Comparative Example 1 | 30 | 1.9 |
| Comparative Example 2 | 35 | 1.8 |
| Comparative Example 3 | 40 | 1.7 |

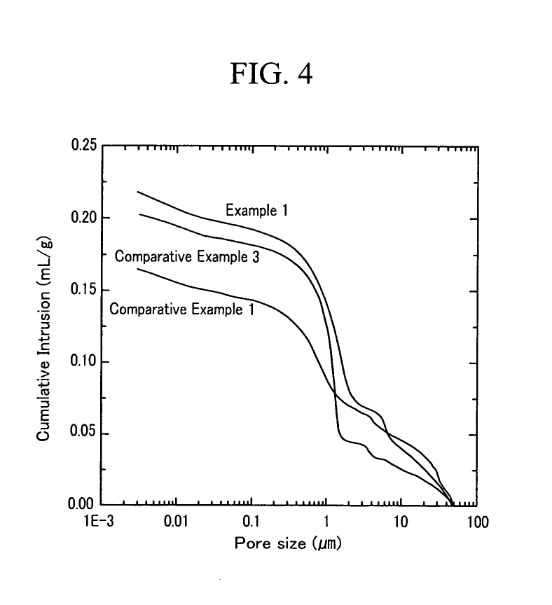

The negative electrodes of Example 1 and Comparative Examples 1 and 3 were examined to measure their pore size distribution in the active material layer by using porosimetry (Porosizer 9320, Micromeritics, USA). The results are shown in FIG. 4.

As shown in FIG. 4, the amount of cumulative intrusion in the negative electrodes of Example 1 is higher than those of the negative electrodes of Comparative Example 1 and 3. Therefore, the negative electrode of Example 1 has a higher porosity and content of the micropores than negative electrodes of Comparative Example land 3.

Fabrication of a test cell for charge and discharge test The negative electrodes prepared according to the processes of Examples 1 to 5 and Comparative Examples 1 to 3 were respectively used as a working electrode, and a thin metal lithium film cut out as a disc with the same diameter was used as a counter electrode. Then, a separator was inserted between the working electrode and the counter electrode. Furthermore, an electrolyte solution was prepared by mixing propylenecarbonate (PC), diethylcarbonate (DEC), and ethylenecarbonate (EC) in a ratio of 1:1:1, and thereafter dissolving LiPF₆ in a concentration of 1.3 mol/L therein. The electrolyte solution was used, fabricating a coin-type cell.

The coin-type cell was initially charged with 0.005 V or 1000 mAh/g, and discharged up to 1.0 V. Herein, its C-rate was regulated within 0.2 C [symbol] 0.2 C. It was charged up to the same potential as the first one by regulating a cut-off of 0.005 V from the second cycle, and was discharged up to 1.0 V. Herein, its C-rate was regulated within 0.2 C [symbol] 0.2 C as in the first charge and discharge. Its cycle-life was calculated as a percent ratio of capacity when it was charged at 0.2 C and discharged for 50 cycles against the initial capacity.

In addition, when it was charged at 1 cycle, the negative electrode was examined to measure its thickness expansion rate in accordance with the Equation 1. The results are shown in Table 2.

Negative electrode expansion rate(%)=[(thickness of electrode after 1 time charging−thickness of electrode before charging)/thickness of electrode before charging]×100 Equation 1

TABLE 2

| | Negative | | | | | | |
|---|---|---|---|---|---|---|---|
| | electrode | | | Initial | Initial | | |
| | expansion | Initial charge | Initial charge | discharge | discharge | Initial | |
| | rate | capacity | capacity | capacity | capacity | efficiency | Cycle-life |
| | (%) | [mAh/cc] | [mAh/g] | [mAh/cc] | [mAh/g] | [%] | [%] |
| Example 1 | 40 | 1237.5 | 990 | 931.25 | 745 | 75 | 90 |
| Example 2 | 40 | 1237.5 | 990 | 931.25 | 745 | 75 | 90 |
| Example 3 | 40 | 1237.5 | 990 | 931.25 | 745 | 75 | 90 |
| Example 4 | 65 | 1287 | 990 | 968.5 | 745 | 75 | 75 |
| Example 5 | 30 | 1178.1 | 990 | 886.55 | 745 | 75 | 88 |
| Comparative | 150 | 1881 | 990 | 1420 | 710 | 73 | 40 |
| Example 1 | | | | | | | |
| Comparative | 130 | 1890 | 990 | 1400 | 745 | 74 | 50 |
| Example 2 | | | | | | | |
| Comparative | 110 | 1864 | 950 | 1380 | 745 | 74 | 60 |
| Example 3 | | | | | | | |

As shown in Table 2, the cycle-life characteristic of a battery varies depending on porosity and mass density inside an active material layer. In other words, the battery including an electrode including pores according to Examples 1 to 5 turned out to have a sharply improved electrode expansion rate, initial charge-discharge capacity and cycle-life characteristic compared with the battery not including pores according to Comparative Example 1 and the batteries having low porosity according to Comparative Example 2 and 3.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electrode for a rechargeable lithium battery comprising:
a current collector; and
an active material layer disposed on the current collector and comprising an active material, the active material layer having pores, porosity of the active material layer being higher than 50% and no higher than 70%.

2. The electrode of claim 1, wherein the active material layer has active mass density ranging from 0.8 g/cc to 2.0 g/cc.

3. The electrode of claim 1, wherein the active material layer further comprises a material selected from the group consisting of a monomer of an unzipping polymer, a plasticizer, an organic template, and mixtures thereof.

4. The electrode of claim 3, wherein an amount of the material, selected from the group consisting of a monomer of an unzipping polymer, a plasticizer, an organic template, and mixtures thereof, is equal to or less than 1000 ppm based on the total weight of the active material layer.

5. The electrode of claim 4, wherein the monomer of an unzipping polymer is selected from the group consisting of alkylmethacrylate, vinylbutyral, and mixtures thereof.

6. The electrode of claim 4, wherein the plasticizer is selected from the group consisting of polyhydric alcohol, alkylcitrate, aliphatic polyester, alkylenecarbonate, and mixtures thereof.

7. The electrode of claim 4, wherein the organic template is selected from the group consisting of polyalkyleneglycol, polystyrene, alkylammoniumhydroxide, alkylammoniumhalide, and mixtures thereof.

8. The electrode of claim 1, wherein the active material is selected from the group consisting of Si, SiOₓ (0<x<2), Sn, SnO₂, and a metal-transition element alloyed with a metal selected from the group consisting of Si, Sn, Al, and combinations thereof.

9. A manufacturing method for an electrode for a rechargeable lithium battery, comprising:
preparing a composition for forming an active material layer, the composition comprising an active material, a pore-forming agent, and a binder;
coating a current collector with the composition; and
drying or heating the composition-coated current collector to form an active material layer on the current collector.

10. The method of claim 9, wherein the pore-forming agent is selected from the group consisting of an unzipping polymer, a plasticizer, an organic template, and mixtures thereof.

11. The method of claim 10, wherein the unzipping polymer is selected from the group consisting of an acrylate-based polymer, a vinyl-based polymer, and mixtures thereof.

12. The method of claim 10, wherein the plasticizer is selected from the group consisting of polyhydric alcohol, alkylcitrate, aliphatic polyester, alkylenecarbonate, and mixtures thereof.

13. The method of claim 10, wherein the organic template is selected from the group consisting of polyalkyleneglycol, polystyrene, alkylammonium hydroxide, alkylammoniumhalide, and mixtures thereof.

14. The method of claim 9, wherein an amount of the pore-forming agent ranges from 0.01 wt % to 20 wt % based on the total weight of the composition for forming the active material layer.

15. The method of claim 9, wherein the binder is selected from the group consisting of polyvinylalcohol, carboxymethylcellulose, hydroxymethylcellulose, diacetylene cellulose, polyvinylchloride, carboxylated polyvinylchloride, polyvinyl difluoride, an ethylene oxide-containing polymer, polyvinylpyrrolidone, polyurethane, polytetrafluoroethylene, polyvinylidenefluoride, polyethylene, polypropylene, styrene-butadiene rubber, acrylated styrene-butadiene rubber, an epoxy resin, nylon, polyimide, polyamideimide, and mixtures thereof.

16. The method of claim 9, wherein the binder includes polyimide.

17. The method of claim 9, wherein an amount of the binder ranges from 1 wt % to 10 wt % based on the total weight of the composition for forming the active material layer.

18. The method of claim 9, wherein the step of drying or heating is performed at a temperature between 50° C. and 500° C.

19. The method of claim 9, wherein the step of drying or heating is performed under an atmosphere selected from the group consisting of vacuum, air, and an inert gas atmospheres.

20. A rechargeable lithium battery comprising:
an electrolyte;
a positive electrode; and
a negative electrode, the positive electrode or the negative electrode comprises:
a current collector; and
an active material layer disposed on the current collector and comprising an active material, the active material layer having pores, porosity of the active material layer being higher than 50% and no higher than 70%.

21. The rechargeable lithium battery of claim 20, wherein the active material layer has active mass density ranging from 0.8 g/cc to 2.0 g/cc.

22. The rechargeable lithium battery of claim 20, wherein the active material layer further comprises a material selected from the group consisting of a monomer of an unzipping polymer, a plasticizer, an organic template, and mixtures thereof.

23. The rechargeable lithium battery of claim 22, wherein an amount of the material, selected from the group consisting of a monomer of an unzipping polymer, a plasticizer, an organic template, and mixtures thereof, is equal to or less than 1000 ppm based on the total weight of the active material layer.

24. The rechargeable lithium battery of claim 20, wherein the active material is selected from the group consisting of Si, SiOₓ (0<x<2), Sn, SnO₂, and a metal-transition element alloyed with a metal selected from the group consisting of Si, Sn, Al, and combinations thereof.
